(19) United States
(12) Patent Application Publication
(10) Pub. No.: US 2005/0138834 A1
(43) Pub. Date: Jun. 30, 2005

(54) Fiberglass insulation curing oven tower and method of curing fiberglass insulation

(76) Inventors: David I. Suda, Warrington, PA (US); Larry Clevenstine, Trevose, PA (US); Thomas A. Cutherbertson, Royersford, PA (US); Mark C. Buscher, Pine Hill, NJ (US)

Correspondence Address: DUANE MORRIS, LLP;IP DEPARTMENT, ONE LIBERTY PLACE, PHILADELPHIA, PA, 19103-7396, US

(21) Appl. No.: 10/726,986

(22) Filed: Dec. 3, 2003

(51) Int. Cl. F26B 19/00; F26B 25/06

(52) U.S. Cl. 34/394; 34/201

(57) ABSTRACT

In a first embodiment of an insulation manufacturing system and method, the system comprises a curing oven tower for heating uncured or partially cured insulation mats. The curing oven tower includes a plurality of vertical oven zones comprising heat sources through which the insulation mats are moved. In a second embodiment, a insulation manufacturing system is provided including a curing oven tower for heating uncured or partially cured insulation mats. The curing oven tower comprises a heat source and a conveyor system for moving the insulation mats both vertically and horizontally through the curing oven tower in a serpentine path.

### FIELD OF THE INVENTION

The present invention relates to insulation production systems and methods, and more particularly to systems and methods for curing fiberglass insulation.

### BACKGROUND OF THE INVENTION

As part of the process for manufacturing fiberglass insulation products, textile glass or spun glass fibers, or both, which may or may not contain thermoplastic fibers, are deposited on a forming conveyor belt. A fiberglass mat formed on the conveyor belt is then moved through a curing oven in order to remove moisture from the glass mat and to cure the binder used to couple the glass fibers. The curing oven generally includes five or six discrete horizontal oven zones or stages disposed on the manufacturing facility's floor to form a continuous oven. When the stages are combined in a continuous line, the oven occupies significant floor space and be between about 100-500 feet in length and about 20-30 feet in width, depending on the mat that is being formed.

FIG. 1 illustrates a side elevational view of an oven belt assembly 10 disposed within the prior art curing oven. The belt assembly 10 moves the uncured fiberglass mat through the aforementioned oven zones. The assembly 10 includes a top and bottom oven belt 12. The oven belts 12 are counter-driven by drive sprockets 14. The fiberglass mat is fed between the oven belts 12 in area 20. The distance between the belts 12 in area 20 can be adjusted to accommodate products of different thicknesses.

FIG. 2 is a partial, top elevational view of a belt 12. The belt is configured like a tank tread, i.e., it has several different connected steel sections 16 or “flights” separated by spaces 24, about 1/32-1/16″ in width, that allow the sections 16 to separate as the belt 12 moves around a drive sprocket 14. Each flight 24 is bracketed or otherwise coupled to wheels 18 that ride in tracks 22. Tracks 22 are formed in the elliptical shape of the belt 12 (FIG. 1) and serve to support the heavy steel belt as it is driven by sprockets 14. Each flight 16 generally has a perforated pattern (not shown) that allows heated air from each oven zone to pass through the belt and into and through the mat.

As currently employed, each oven zone typically has a height around 30-40 feet. Hot air from the top of each oven zone is recycled through ductwork to the bottom of the respective oven zone by a recirculating fan associated with each oven zone. The recycled hot air tends to lose heat after it has passed through the oven mat and while traveling to the top of the oven zone and through the ductwork that spans the distance from top of the oven zone to the bottom of the oven zone, resulting in an inefficient process despite the recirculation. The recirculating fans, spaced about 25 feet from the side of each oven zone, and associated duct work also tend to consume valuable factory space, including floor space. Each oven zone also includes its own gas burner that serves as a heat source and is typically located to the side of each oven opposite the recirculating fans and spaced about 10 feet from the side of each oven zone.

While the process and system described above produces high quality insulations products, there is presently a need for a more space efficient and heat efficient system and method for curing insulation mats, particularly fiberglass insulation mats.

### SUMMARY OF THE INVENTION

In a first embodiment of an insulation manufacturing system and method, the system comprises a curing oven tower for heating uncured or partially cured insulation mats. The curing oven tower includes a plurality of vertical oven zones comprising heat sources through which the insulation mats are moved.

In a second embodiment, a insulation manufacturing system is provided including a curing oven tower for heating uncured or partially cured insulation mats. The curing oven tower comprises a heat source and a conveyor system for moving the insulation mats both vertically and horizontally through the curing oven tower in a serpentine path.

The system and method for heating uncured or partially uncured insulation mats provide both space and heat efficiency advantages. By utilizing a serpentine-like path for the mats and/or vertical heating zones, valuable factory floor space is preserved. By allowing heated air to pass through or otherwise engage a mat more than once in the air's progression through an oven, heat that may otherwise be wasted is used in the process to heat the mat. Because of the improved efficiencies, it may also be possible to use fewer heat sources, less powerful heat sources, or a combination thereof. Still further, because of the more efficient heating of the insulation mat, it is anticipated that the total distance that a mat must cover and/or the time the mat must be heated may be reduced. The mat may be conveyed at higher speeds, leading to increased output.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a side elevational view of a oven belt assembly of a prior art curing oven;

FIG. 2 is a partial, top plan view of an oven belt of the assembly of FIG. 1;

FIG. 3 is a side elevational view of an embodiment of the belt assembly of a curing oven of the present invention;

FIG. 4 is a system view of a curing oven system including a cross-sectional view of the belt assembly of FIG. 3 taken along lines 4-4.

### DETAILED DESCRIPTION

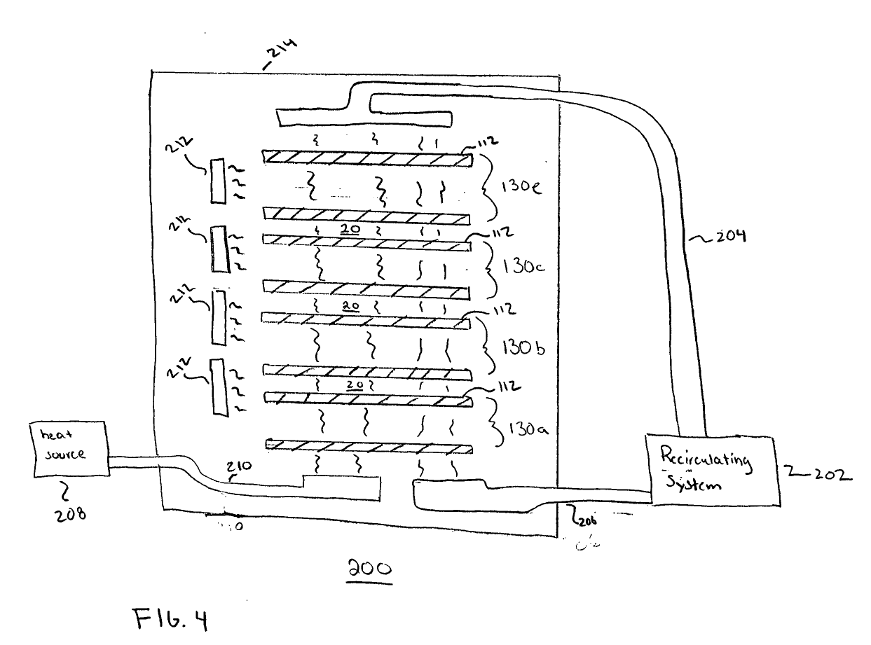

An oven system and method of heating uncured or partially cured insulation are described below in connection with FIGS. 3 and 4. In an exemplary embodiment, the method and system are used to heat and cure uncured or partially cured fiberglass insulation, such as insulation batts and acoustic insulation panels, in mat form comprising glass fibers, plastic fibers or plastic-coated glass fibers coated with an uncured or partially cured resinous binder.

The improved oven system and method described below are described primarily with respect to the belt assembly that moves the insulation mat through the oven system. The remaining portions of a fiberglass insulation fabrication system, except as shown in FIG. 4, and process are not described in detail herein in order to avoid obscuring the focus of the description of the improved system and method. One of ordinary skill in art of insulation fabrication, however, should be familiar with the components and operation of such systems.

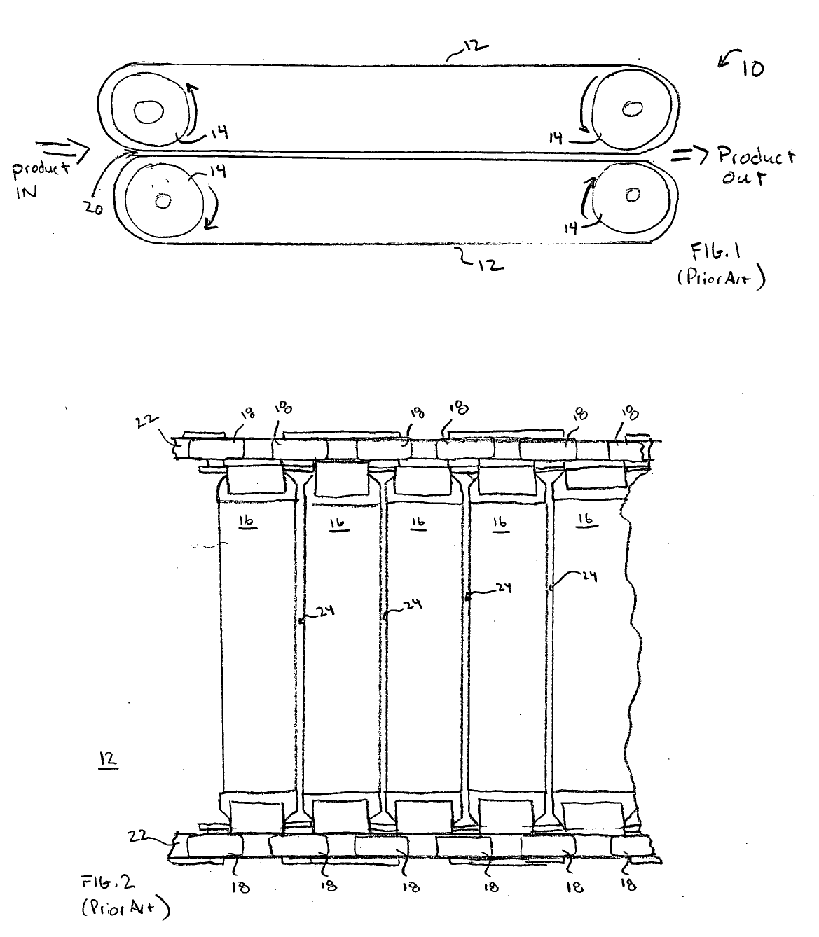

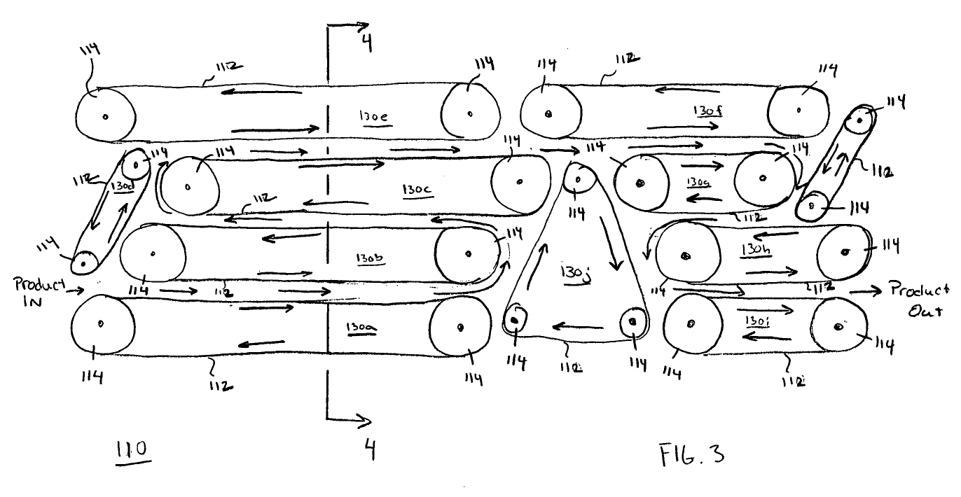

A curing system includes a plurality of vertically oriented oven zones or stages. In one embodiment, a conveying means moves the fiberglass mat through the curing tower and through the oven zones. FIG. 3 is a side elevational view of one embodiment of a belt assembly 110 of a curing oven for conveying the uncured or partially cured fiberglass mat through the curing oven tower. As can be seen from FIG. 3, in one embodiment, the belt assembly 110 includes a plurality of cooperating conveyors 130 arranged to move the insulation mat both horizontally and vertically through the curing oven, such as in a serpentine path shown by the directional arrows between the conveyors 130. By “serpentine,” it is meant a path that has one or more turns. The serpentine path preferably overlaps itself vertically as shown in the embodiment of FIG. 3. Each conveyor includes a pair of drive sprockets 114 and a belt 112 configured, for example, like a belt 12 described above in connection with FIGS. 1 and 2, but appropriately sized for the serpentine configuration.

FIG. 4 illustrates a curing oven system 200 including a curing oven 214 and belt assembly 110. Belt assembly 110 is shown in FIG. 4 in cross-section (taken along lines 4-4 of FIG. 3). Because the mat is conveyed both horizontally and vertically in an overlapping manner, the hot air (illustrated by “wavy” lines) repeatedly passes through (or otherwise engages) and heats the insulation mat as the air rises from the bottom of the curing oven towards the top of the curing oven. This configuration thereby provides for more efficient use of the hot air in the curing process. Previously, once the air passed through the mat a first time, it traveled to the top of the oven and through ductwork to be reused to heat rearward portions of the mat. During this travel, the heated air lost heat while failing to engage or otherwise heat the insulation mat.

Still further, conveying the mat through an overlapping serpentine path greatly reduces the overall length of the curing oven when compared to an oven system including only a substantially horizontal belt assembly 10 (FIG. 1).

It should be understood that several possible patterns and conveying schemes other than that shown in FIG. 3 may be implemented to move the insulation mats in the overlapping vertical and horizontal manner described above. Indeed, a single conveyor pair may be arranged to achieve this functionality. Other possible patterns that limit the horizontal area required for the oven system, such as spirals and helixes, and that can be configured to efficiently expose the mat to the heat generated in the oven and/or reuse the generated heat are also contemplated. Further, although FIG. 3 illustrates the insulation mat entering and exiting the oven in a region proximate to the bottom of the oven, this is by no means a requirement. Rather, the insulation mat could enter and exit at any location between the bottom of the heating oven and top of the heat oven and combinations thereof.

Referring again to FIG. 4, the oven system 200 may include a recirculating system 202 (e.g., fan or pump) for recirculating heated air from a first location or locations within the oven to a second location or locations within the oven. In one embodiment, the recirculating system 202 pulls air from a position proximate to the top of the oven through ducting 204 to a position therebelow, e.g., to a portion proximate to the bottom of the oven through ducting 206 for release and/or reheating. Heat may be provided by one or more heat sources 208, such as gas or other fuel fired heat sources, through ducting 210 to oven 214. In one embodiment, the hot air is initially provided to a point proximate to the bottom of the oven 214, such as below or adjacent to conveyor 130a.

In addition, or alternatively, it is contemplated that the oven 214 can include multiple heating zones each comprising its own heat source or sources. For example, it is also contemplated that one or more heat sources 208 may be used, along with appropriate ducting (not shown), to provide heat at positions proximate to each conveyor 130 or at different vertical positions in the oven (e.g., at different heights). Further, one or more radiant heat sources 212 may be provided along the side walls of the oven 214 at different height and/or horizontal positions to heat the insulation mats as they move through the oven via the conveyor assembly 110. In essence, the vertical nature of the heating oven allows for the more strategic placement of heat sources both vertically and horizontally in the oven, e.g., either along the oven walls (or floor) or via ductwork that brings heated air to various selected locations within the oven 214.

As described above, the system and method for heating uncured or partially uncured insulation mats, such as fiberglass insulation, provide advantages in both space and heat efficiency. By utilizing a serpentine-like path for the mats and/or vertical heating zones, valuable factory floor space is preserved. By allowing heated air to pass through a mat more than once or engage a mat substantially continuously in the air's progression through an oven, heat that may otherwise be wasted (such as heat lost in the recirculation process of the prior art) is used in the process to heat the mat. Because of the improved efficiencies, it may also be possible to use fewer heat sources, less powerful heat sources, or a combination thereof. For example, radiant heat sources disposed more proximate to the bottom of the oven 214 may be selected or configured to produce more heat than heat sources disposed more proximate to the top of the oven 214 (where the rising heat from the bottom most heat sources is also used to heat the insulation mat). Still further, because of the more efficient heating of the fiberglass mat, it is anticipated that the total distance that a mat must cover and/or the time the mat must be heated may be reduced. The mat may be conveyed at higher speeds than the present maximum of around 200 feet per minute (depending on the product), leading to increased output.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

1. An insulation manufacturing system comprising a curing oven tower for heating an uncured or partially cured insulation mat, said curing oven tower comprising a plurality of vertical oven zones comprising heat sources, and a conveyor system comprising a plurality of pairs of counter-rotating conveyors disposed to move said mat through said plurality of vertical oven zones for curing, said mat being disposed between said counter-rotating conveyors.

2. (canceled)

3. The system of claim 1, wherein said conveyor system comprises rotating conveyors cooperating to move said insulation mat both horizontally and vertically through said curing oven tower in a serpentine path.

4. The system of claim 3, wherein said path vertically overlaps itself.

5. (canceled)

6. (canceled)

7. The system of claim 1, further comprising recirculating means for recirculating air from a region proximate to the top of said curing oven tower to a region proximate to a bottom of said curing oven tower.

8. A method of curing insulation comprising moving an uncured or partially cured insulation mat through a curing oven tower, said curing oven tower comprising a plurality of vertical oven zones comprising heat sources, said moving step including the step of moving the insulation mat through the plurality of vertical oven tones for curing.

9. (canceled)

10. The method of claim 8, wherein said moving step includes the step of moving said insulation mat both horizontally and vertically through said curing oven in a serpentine path.

11. The method of claim 10, wherein said path vertically overlaps itself.

12. The method of claim 11, wherein said moving step includes the step of conveying said insulation mat with a plurality of conveyors disposed to move said insulation mat both horizontally and vertically through said oven tower.

13. The method of claim 12, wherein said plurality of conveyors comprises a plurality of pairs of counter rotating conveyors that cooperate to move said insulation mat through said oven tower.

14. The method of claim 8, further comprising the step of recirculating air from a region proximate to the top of said curing oven tower to a region proximate to a bottom of said curing oven tower.

15. The method of claim 8, wherein said insulation mat comprises glass fibers.

16. A insulation manufacturing system comprising a curing oven tower for heating an uncured or partially cured fiberglass insulation mat, said curing oven tower comprising a heat source and a conveyor system comprising cooperable pairs of counter-rotating conveyors arranged for moving said insulation mat(s) both vertically and horizontally through said curing oven tower in a serpentine path.

17. (canceled)

18. (canceled)

19. (canceled)

20. The system of claim 16, farther comprising recirculating means for recirculating air from a region proximate to the top of said curing oven tower to a region proximate to a bottom of said curing oven tower.

21. The system claim 16, wherein said serpentine path vertically overlaps itself.

22. A method of curing insulation comprising moving an uncured or partially cured insulation mat both horizontally and vertically in a serpentine path through a curing oven tower comprising a heat source.

23. The method of claim 22, wherein said, said curing oven tower comprises a conveyor system for moving said insulation mat both vertically and horizontally through said curing oven tower, said moving step comprising the step of conveying said insulation mat with said conveyor system.

24. The method of claim 23, wherein said conveying step includes the step of conveying said insulation mat with a plurality of cooperable conveyors disposed to move said insulation mat both horizontally and vertically through said oven tower.

25. The method of claim 24, wherein said plurality of conveyors comprises a plurality of pairs of counter rotating conveyors that cooperate to move said insulation mat through said oven tower.

26. The method of claim 24, wherein said serpentine path vertically overlaps itself.

27. The method of claim 22, further comprising the step of recirculating air from a region proximate to the top of said curing oven tower to a region proximate to a bottom of said curing oven tower.

28. The method of claim 22, wherein said insulation mat comprises fiberglass.

29. The method of claim 22, wherein said serpentine path vertically overlaps itself.
